(19) United States
(12) Patent Application Publication
(10) Pub. No.: US 2012/0010909 A1
(43) Pub. Date: Jan. 12, 2012

(54) Method and system for enabling on-line travel reservations via connection to customer relationship management system, office software address book, or other electronic sources of contact information

(76) Inventor: Keith Andrew Corell, The Woodlands, TX (US)

(21) Appl. No.: 12/830,767

(22) Filed: Jul. 6, 2010

(51) Int. Cl. G06Q 10/00

(52) U.S. Cl. 705/5

(57) ABSTRACT

A method and system of allowing a user to make travel reservations online via an interface between a customer relationship management (CRM) or like accessible software program intended to facilitate storage and retrieval of addresses and related information for persons, business, & other entities, such as email and other common office software address books and contact lists, where the method captures potential destination information from the CRM or other address/contact list software and presents the user with reservation options. Said options can be presented either via internet or other data transmittal method within the CRM or other software tool, or may be accomplished by sending departure, destination, and other information to a third system for display and reservation booking, either with or without sign-on to such a system. Once reservations are complete, travel data (including, but not limited to, date, time, air carrier, and traveler details) is then returned to the CRM or other software tool for tracking, travel reminders, or travel reporting purposes.

### BACKGROUND OF THE INVENTION

1. Field of the Invention

This invention generally relates to software applications used to track customer or other contact information and how these might access online booking tools used to make travel reservations.

2. Background Art

Currently, if a user of a Customer Relationship Management (CRM) or similar tool identifies the need to book a reservation, it is a manual process to switch between software applications to access an online booking tool. The tool, typically a web-based application serviced by a travel agency and displaying content pulled from a global distribution system (GDS), allows the user to input destination data and needed dates, and then select flights from a selection returned by a search of the available GDS inventory.

The user can then make notes of the trips selected or manually enter this information into the CRM, if that application allows such notes. Some online booking tools allow access to reservation information via email automatically generated by the tool and sent to the user, who can then log such trips in their personal calendar software, such as in Microsoft Office, Lotus Notes, and Open Office.

To report scheduled trips, as a pending travel report to a company's management for example, the user's organization must typically defer to reporting generated by the agency that fulfills the ticket reservations, either direct from the agency or via self-serve reporting via the agency's online reporting portal. These reports sometimes lack real-time visibility to all scheduled trips, and force intervening steps and use of several software applications or systems to create the final report.

### SUMMARY OF THE INVENTION

An object of this invention is to allow the users of a CRM or other contract or address tracking software to quickly and efficiently make travel reservations to the location displayed in said software for the contact being viewed, by an automatic link to an online booking tool. Accessing the link would allow transmission to the booking tool of destination data, such as the contact's city, state, and country, and can be linked to tables within the CRM tool that contain reference information, such as closest airports to the contact, the organization's preferred hotel providers, and the like.

Another object of this invention is to allow a similar user to more generally access an online booking tool directly from all sections of the CRM or aforementioned software programs, without necessarily selecting a specific contact's location, as a convenience to the user.

A further object of this invention is to transmit certain information to the booking tool to identify the user to the tool, which then allows a quick sign-in process, a well as the user's previously stored preferences (typically kept in a traveler profile) to be used in the booking of the reservation. The linkage can include secure information to allow a single-sign-on (SSO) enabled system to log in the user to the tool automatically, or may prompt the user to enter a password before proceeding.

Yet another object of this invention is to allow the return of data from the booking tool to the original CRM or aforementioned software programs. This data would include confirmed travel date(s) and flight number(s), carrier, hotel accommodations, car reservations, and other pertinent trip-related information. This information can then be displayed as reminders to the user when utilizing the software programs, both on the home screens, and in direct relation to the specific contact. The invention would programmatically suggest other contacts the user could visit based on those contacts' addresses in relation to the destination(s) booked. The information would also then be available to the user's management (if part of a larger organization, such as a business, government agency, or non-profit organization) via direct display in the software's reporting dashboards, status screens, or other common methods of reviewing user behavior, or via reporting as supported in the program's addressable databases.

These and other objectives are achieved via a method and system for enabling a CRM or other aforementioned software programs to link and transmit data bi-directionally to an online travel booking tool. The method comprises the steps adding a link to the booking tool within the CRM or other aforementioned software programs, designating what information will be transmitted (if any) when the link is used, determining how the tool will be accessed, and then accepting returned data once the reservation is complete.

In accordance with the preferred embodiment of the invention, an icon hyperlinked to a URL is placed in a prominent but unobtrusive place in the user interface where the aforementioned software's user reviews a contact's information. This link would be placed as a small icon in the one corner of the contact information screen, and would include a description for its use when the user highlights it with a mouse.

In the preferred embodiment, when the link is clicked, the software opens a second window that displays the user's designated online booking tool. In an SSO environment, the user's secure credentials would be included in the link's initial communication with the booking tool, allowing the initial sign-in screen to be bypassed. In a non-SSO environment, the user would sign in with user name and password. Once securely accessing the tool, the user's departure information would be entered automatically via information transmitted by the link, if not already included by addressing the user's travel profile. The destination would also be populated, based on the contact's information sourced from the CRM or aforementioned software programs. The user would then enter dates and other criteria, search for fares, and complete the reservation as is the norm for users of these online tools.

The preferred embodiment of the invention would then see the confirmed flight and other travel information conveyed back to the CRM or aforementioned software program for capture in the software's database. Subsequent reviews of the contact's information would display a changed icon that represents a pending trip until the date & time of the trip had passed. Clicking this link displays a summary of the trip, rather than take the user directly to the booking tool, though a second link included in this screen allows the user to access the booking tool to make changes to the reservations if needed. The trip information is also displayed to the user's manager as a trip notice, and can then be included in an organization's travel report when such is run. All trips booked are tracked within the CRM or aforementioned software for the user's review, to prevent overlapping trips from occurring, and to display reports on other contacts that may be visited based on trip destination(s) and dates of travel.

### DETAILED DESCRIPTION OF THE PREFERRED EMBODIMENTS

In the preferred embodiment of the invention, an icon hyperlinked to a URL is placed in a prominent but unobtrusive place in the user interface where the aforementioned software's user reviews a contact's information. Such interfaces are typically represented graphically as note or Rolodex cards on the user's computer screen, and contain the contact's name, title, email and physical addresses, phone numbers, and the like. In CRM systems, the contact information can also include a history of call dates, in-person visits, and products and services previously purchased. This invention's link—for the purpose of this description the “Book Travel” link, but similarly brief, descriptive text can be used to accompany the graphical icon—would be placed as a small icon in the one corner of the card representation, and would include a description for its use when the user highlights it with a mouse.

A similar Book Travel link would also be prominently displayed in the aforementioned software's main web pages or primary interface screens. Clicking this link would initiate access to an intermediate screen or interface, where the user would be able to select a contact to be visited from a list of contacts. Once the contact is selected, the process would proceed to the booking stage as described below. Once the Book Travel link is clicked from the selected contact's page or screen, the preferred embodiment have would proceed to open the online travel booking site, either as a second, separate screen or by moving the web interface to the screen directly. The user would be able to select via which of these options the travel screen is displayed. If in a single sign-on (SSO) network environment, the users security credentials entered upon initial access to the network would suffice to log the user into the online travel booking tool. In a non-SSO environment, the user would be prompted to enter user name and password(s) or other security information to log into the booking tool.

At this point, a second screen—commonly referred to as a “pop-up”—would be displayed in addition to the booking tool screen, which would display other contacts in the same geographic area as the initially selected contact. The user would then be able to select one or more of these additional contacts to be included in the trip database once the booking is complete as outlined below.

In the preferred embodiment, once logged in, the online booking tool's trip creation screen would be displayed with both departure and destination locations pre-populated with information conveyed via the user's preferences and selected contact's address information, as conveyed from the contact screen in the CRM or aforementioned software. In the current art, most booking tools including “home airport” or similar information included in a stored traveler profile, but the preferred embodiment supplies this information for occasions when profile information is not available. This transmitted information could be in the form of the actual, complete address of the user and contact, or could be restricted to the Airport City Code, depending on the requirements specified in the booking tools configuration.

The user would proceed to choose travel dates, search for fares, and book the remainder of the trip as outlined by the dictates of the online booking tool. In the preferred embodiment, the booking tool would transmit trip-related data back to the CRM or aforementioned software once the booking was completed. The user would initiate transmission via a graphical link on a screen in the booking tool that appears once the trip is finalized. Transmitted data would include the flights date(s) and time(s), departure and destination information, carrier, hotel & car rental details, and other information as needed. Data may also be supplied to the aforementioned software via email, secure file transmission protocol (FTP), or other methods in common use.

Once the trip data is received, the preferred embodiment would store the data in a database for a variety of uses. When subsequently viewing a contact's details, the original Book Travel link would now be displayed as an altered icon—Booked Travel, or similarly named—to indicate that a trip has already been scheduled to this contact. Clicking the Booked Travel icon would display information on the current trip planned to the contact's location, with another link provided if the user needs to modify the travel plans, which would take the user to the online booking tool as outlined above.

When accessing the aforementioned software generally, the data would serve to provide the user graphical reminders of all trips currently planned via a section on the software's primary display. Following standards of the current art, this would typically occur via a webpage-type interface, with a section on the side bar or reach via drop-down menu titled “Planned Trips” or similar phrasing. The Planned Trips section would display the contact name and trip date, with hyperlinks links embedded in each line to allow the user to click through to view the full details. As a subsection, the data would also be matched to all contacts' address information to display other contacts with whom the user could schedule appointments either during the scheduled duration of the trip, or via modification to the existing itinerary's date and/or time of departure. Those knowledgeable in the art will appreciate the potential for cost savings created by the user's ability to make more appointments or visits to the user's contacts on the same trip, without incurring additional airfare.

The preferred embodiment would also use the trip database to provide reports to the user's manager for viewing the user's scheduled trips. Where desired, the trips can also be reviewed as requests, to be approved or rejected by the manager within the CRM system (most booking tools on the market have some provision for online and/or email based travel approvals). The manager would also have available travel reports for all of the manager's employees, and subsequent layers of management would see similar reports for their organizations, up to and including the organization's overall leader. Reports would include various views of the data, such as by date, destination, contact visited, and other views standard in the art of travel and CRM reporting.

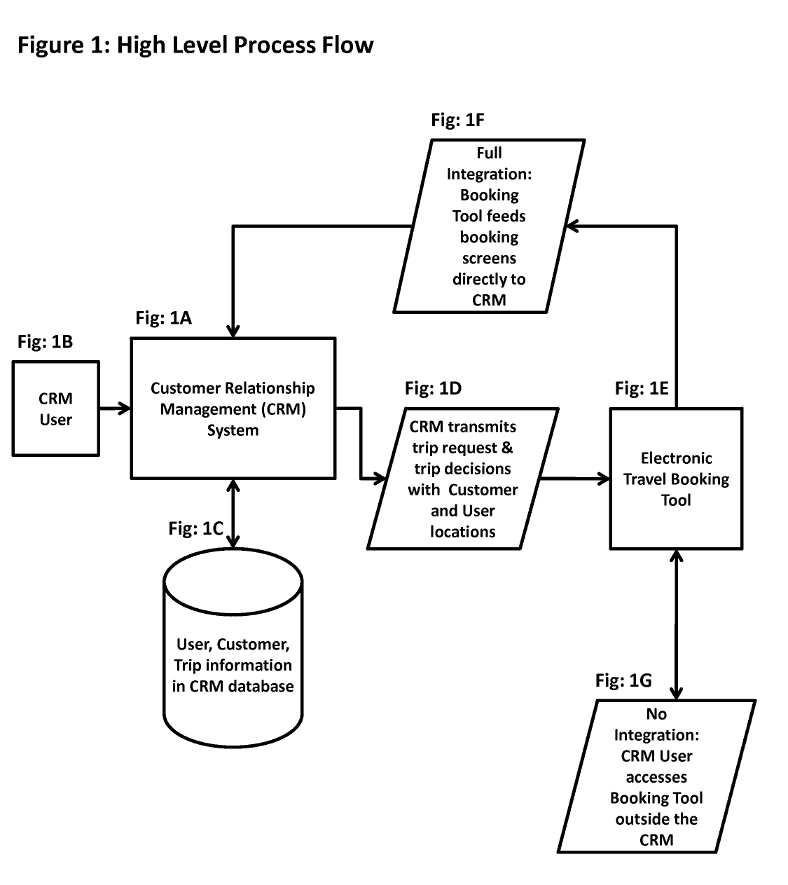

FIG. 1 shows the process for the preferred embodiment described herein, using a CRM application (A) as the source for customer data (C). The CRM user (B) access the CRM system, reviews stored customer data, and chooses to book travel to a customer. This results in the customer's and user's locations being transmitted as a booking request (D), to the chosen Booking Tool (E). With a full integration to the CRM (F), this does not require a second sign-on to the Booking Tool search fares, but instead is performed inside a screen within the CRM itself. Without a full integration, the user complete the fare search and completes the booking within the external Booking Tool (G).

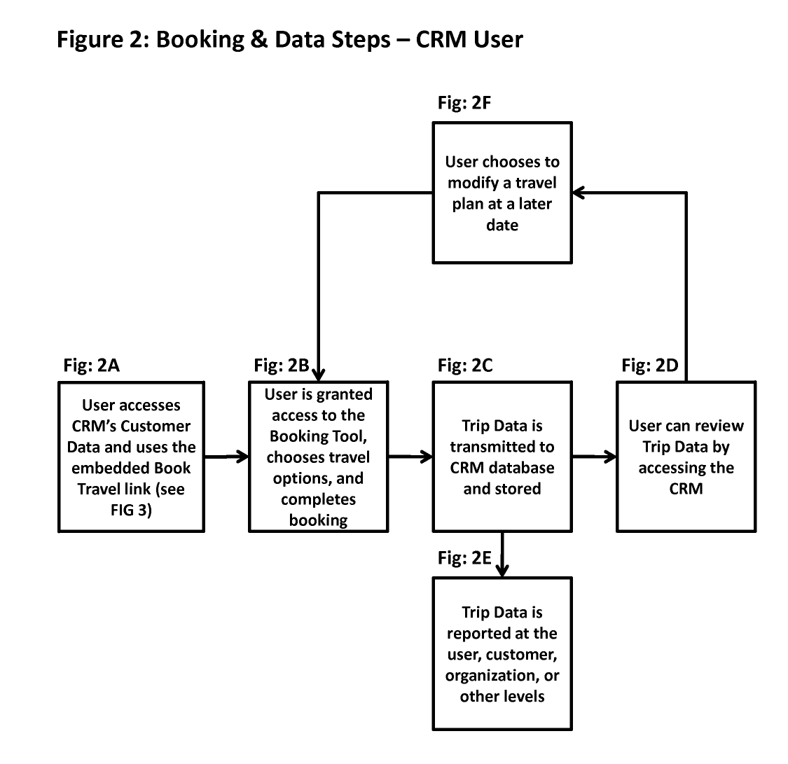

FIG. 2 provides more detail in the steps taken for a user to complete a booking in the preferred embodiment. User reviews customer data and clicks the Book Travel link (A), uses the Booking Tool interface to make travel selections (B), with the completed information sent to the CRM for storage (C). User can review the trip details for all pending trips (D) and request a trip change (E) if needed. Up-to-date trip information is provided via reports at the user, manager, customer, or other aggregation methods (F).

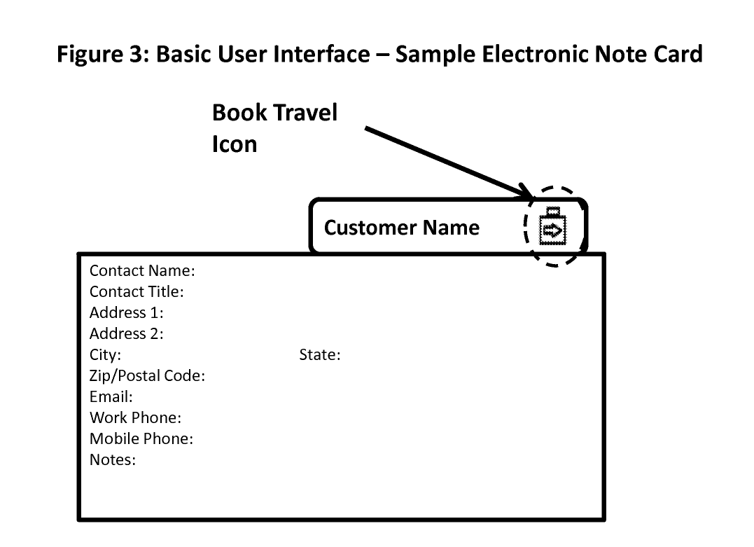

FIG. 3 displays as sample electronic address card in a format analogous to a physical Rolodex card. Other formats for capturing and displaying contact information exist in various forms, varying from software application to application, and this should not be taken as the sole format for which the preferred embodiment can be utilized. In this sample, the Book Travel icon is displayed next to the Customer Name, and is represented by a suitcase with an arrow, though other graphical representations could exist to indicate the link is for travel such as globes, maps, aircraft, and the like.

The present invention can be embodied in either software run on multiple individual computer systems, such as desktops, laptops, and servers, or could be configured to run of software localized to a specific machine or machines designed for the sole purpose hosting the application described herein. Software, programs, and applications are herein intended to describe a method by which a set of instructions are created, stored, and then applied via use of a computer's operating system, the instructions of which are written in a variety of development languages or codes and then compiled to be executable by an operating system.

Though the herein described invention is rigorous in its methods for fulfilling the objectives communicated above, modifications and embodiments may be made by those skilled in the art which should be considered to fall within the purview and scope of the present invention as outlined in the appended claims herein.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of allowing the user of customer relationship management (CRM) or other software typically used for tracking contacts and address information for persons, businesses, or other entities to initiate online booking of travel reservations, which typically includes air or rail transportation, hotel accommodations, car rental or acquiring a car for hire, and/or restaurant availability and reservations, where the online booking tool is reached via a link within the CRM or other previously described software.

2. The method of claim 1 wherein the link is displayed as either a text string or a pictorial icon that would indicate its intended use for reaching the travel booking tool, and which contains an embedded URL or other electronic linking method.

3. The method of claim 2 wherein the link accesses an online booking tool run from a server internal to the user's company, externally via the CRM or other software if a hosted application, externally via a third party travel agency's online booking tool, or via other methods common to the industry.

4. The method of claim 2 wherein access to the online booking tool may occur within the CRM or other aforementioned software programs as an application contained within said software, or may be accomplished via opening another application or internet browser to access the online booking tool outside of the original software application.

5. The method in claim 1 wherein the CRM or other aforementioned software programs has the link accessible for use on the software's initial or home pages or screens, user-created pages or screens, on portions of the pages & screens typically referred to as “sidebars” or “menu bars”, and/or as components of the individual contacts' displayed information, either directly accessible or via drop-down selection, such that the user may select the link when the need to access the online tool is determined.

6. The method of claim 1 wherein accessing the link is accomplished without sending information that identifies the user.

7. The method of claim 1 wherein accessing the link transmits information used to identify the user of the link, such that the online booking tool can recognize the user, allow the user to securely log in or log in automatically in a single-sign-on (SSO) environment, and then access the user's history, scheduled flights, preferences, travel profile, and other information commonly displayed as a user books travel reservations online.

8. The method of claim 1 wherein accessing the link transmits information related to the user's current address, preferred address, or home city to the online booking tool, such that the tool will, automatically or via prompt, pre-populate the needed departure information in the tool's search feature.

9. The method of claim 1 wherein accessing the link transmits information related to the customer or other contact's address information to the online booking tool, such that the tool will, automatically or via prompt, pre-populate the needed destination information in the tool's search feature.

10. The method of claim 9 wherein accessing the link initiates a notation or pop-up window to the user that lists other contacts located within a given radius of the contact whose destination is being supplied to the booking tool, and which can then be selected to be included as data points within any trip subsequently booked.

11. The method of claim 1 wherein once the travel reservation has been made via access to the online booking tool, the booking tool can return information to the original CRM or other aforementioned software programs, such that this software can then log details of the travel reservations made for the specific customer or contact site by the user.

12. The method of claim 11 wherein the information transmitted from the booking tool to the CRM or other aforementioned software programs includes, but is not limited to, flight dates and carrier, details on hotel accommodations, car arrangements, and other travel booking-related information.

13. The method of claim 11 wherein this information is viewable in the CRM or other aforementioned software programs by the user, user's management, or other designated parties, as either displayed information convenient to the contact's record, or via reporting from a database which extracts such information from the CRM or other aforementioned software programs.

14. The method in claim 11 wherein this information is be used to initiate travel reminders sourced directly from the CRM or other aforementioned software programs.

15. The method in claim 11 wherein the trip information is compared to other trips booked within the trip's timeframe such that the CRM or other aforementioned software programs can notify the user when trips conflict in terms of dates, times, and/or originating & departing airport locations.

16. The method in claim 11 wherein the trip destination information is compared to other stored contacts' addresses such that the CRM or other aforementioned software programs can suggest other contacts that could be visited during the booked trip's duration, or if the booked trip's flight times or dates are modified.

17. The method in claim 11 wherein the trip information is provided to one or more applicable trip approvers within the CRM or other aforementioned software programs, who can then approve, reject, or request more information about the trip.
